(19) United States
(12) Patent Application Publication
(10) Pub. No.: US 2011/0111130 A1
(43) Pub. Date: May 12, 2011

(54) PROCESS FOR COATING METAL BANDS

(75) Inventors: Markus Hickl, Dusseldorf (DE); Alexandra Steffens, Münster (DE)

(73) Assignee: BASF COATINGS GMBH, Münster (DE)

(21) Appl. No.: 12/994,941

(22) PCT Filed: Apr. 30, 2009
(86) PCT No.: PCT/EP2009/003122

§ 371 Date: Jan. 6, 2011

(30) Foreign Application Priority Data
May 28, 2008 (DE) 10 2008 025 514.9
Nov. 26, 2008 (DE) 10 2008 059 014.2

(51) Int. Cl. B05D 3/10

(52) U.S. Cl. 427/388.2

(57) ABSTRACT

The invention describes a method of coating coils, comprising the following steps: (1) applying an aqueous primer coating composition (B) comprising at least one crosslinkable binder system (BM), at least one filler component (BF), at least one corrosion control component (BK), and volatile constituents (BL), to the optionally cleaned metal surface, the coating composition (B) having an organic solvent content of not more than 15% by weight, based on the volatile constituents (BL) of the coating composition (B), (2) drying the integrated pretreatment film formed from the primer coating composition (B), (3) applying a topcoat film (D) to the integrated pretreatment film dried as per step (2), and (4) jointly curing the films of coating composition (B) and topcoat (D).

Methods and compositions for the coating of coils (metal strips) are known. In general the coating compositions are applied in three coating stages.

In a first stage, after the coil has been unwound and cleaned with an alkaline pickling solution, followed by a rinse with water, a pretreatment composition is applied to the coil in order to increase the corrosion resistance. For this purpose the aim has been more recently to develop chrome-free pretreatment compositions which ensure very good corrosion control comparable with that of chrome-containing coating compositions. In this context, pretreatment compositions comprising salts and/or complexes of the d-shell elements as their inorganic component have emerged as being particularly suitable. Preferred pretreatment solutions generally further comprise adhesion promoters, such as silanes, for example, which are intended to ensure adhesion to the metal substrate and to the subsequent coats, and a small fraction of preferably water-soluble polymers, which serve generally not so much to form a film as to exert targeted control over the crystal growth of the abovementioned inorganic components. The pretreatment composition is applied to the coil generally by spraying (rinse method, with subsequent rinsing) or by means of a Chemcoater (no-rinse method: no rinsing). Thereafter the coil coated with the pretreatment composition is dried at a maximum coil temperature (PMT, i.e., peak metal temperature) of around 90° C.

In the second stage, a primer is coated, preferably by means of roller application, onto the coil precoated as per the first stage. These primers, almost exclusively, comprise solvent-based coating systems, which are applied at a wet film thickness such that drying and curing result in a film thickness of 4 to 8 μm. The primer compositions generally comprise polyesters, polyurethanes, epoxy resins and/or, less commonly, polyacrylates as their binder components and melamine resins and/or polyisocyanates as their crosslinker components. The curing of the primer film takes place in general at a PMT between 220 and 260° C. in a baking oven, the coil being shock-cooled by a water curtain after exiting the baking oven, and thereafter being dried.

In the third and final stage, the coil precoated as per the second stage is overcoated with a topcoat, the topcoats being applied at a wet film thickness such that drying results in a film thickness of 15 to 25 μm, and the curing of the topcoat film takes place in general at a PMT between 220 and 260° C. in a baking oven.

Since the above method is complicated and energy-intensive, there has been no lack of attempts to simplify the method, more particularly to condense the steps of the method, and to reduce the energy consumption of the method.

Thus, for example, WO-A-2007/125038 describes a method of coating metal coils that integrates the pretreatment composition into an aqueous primer coating. This is achieved using special copolymers containing monomer units with N-heterocycles, monomer units with acid groups, and vinylaromatic monomer units, as corrosion inhibitors. As crosslinkable binders it is possible to employ binders that are typical within the field of coil coating materials and which exhibit sufficient flexibility. Preferred binders according to WO-A-2007/125038 are poly(meth)acrylates and/or styrene-acrylate copolymers, styrene-alkadiene copolymers, polyurethanes, and alkyd resins. The primer films described are baked before the topcoat materials are applied. The leveling and the overcoatability of such primer coats, however, are heavily dependent on the selection of the binder components and are often difficult to adjust. More particularly, the separate baking step for the primer coating is energy-intensive and hence less than optimum both environmentally and economically.

WO-A-2005/047390 describes primers which comprise water-dispersible polyurethanes containing acid groups as binders, which are neutralized with amines containing crosslinkable groups. Before the topcoat film is applied, the primer films are cured, i.e., crosslinked, in a separate, energy-intensive baking step, the specific selection of the amines preventing a hindering effect on the acid-catalyzed curing of the topcoats, which otherwise leads to wrinkling and to defects of metallic appearance in the topcoat film. With systems of this kind as well, leveling and overcoatability of the primer coating are heavily dependent on the selection of the binder components, and the separate baking step for the primer coating is energy-intensive and hence less than optimum both environmentally and economically.

WO-A-01/43888 describes a method in which the topcoat film is applied to an undried film of a pretreatment composition, the undried film of the pretreatment composition being required to have a certain conductivity that is necessary for the application of the topcoat film, and the topcoat material preferably being a powder coating material. Where topcoat materials of this kind are used, if the degree of moisture of the film of pretreatment composition is high, there is unwanted mixing between pretreatment composition and topcoat material; if the degree of moisture is low, then, again, the leveling and overcoatability of the film of the pretreatment composition are heavily dependent on the selection of the binder components.

### PROBLEM AND SOLUTION

In the light of the above-stated prior art, the problem addressed by the invention was that of finding a method for the application of integrated, low-solvent coating materials combining the functions of corrosion control and of the primer to metal coils that permits the broad usability of binders in integrated coating compositions and leads more particularly to coatings which exhibit very good level and overcoatability. At the same time the primer/topcoat system ought to meet the exacting requirements of the kind imposed on coils coated with such systems, such as, more particularly, corrosion stability, flexibility, and chemical resistance, particularly when these coils are shaped and exposed to weathering. In particular the method ought to allow a reduction in the technical complexity and energy costs through the condensing-down of individual steps in the coil coating operation.

The problem addressed by the invention is solved, surprisingly, by a method of coating coils that has the following steps:
(1) applying a preferably crosslinkable aqueous primer coating composition (B) comprising at least one binder system (BM), at least one filler component (BF), at least one corrosion control component (BK), and volatile constituents (BL), to the optionally cleaned metal surface, the coating composition (B) having an organic solvent content of less than 15% by weight, based on the volatile constituents (BL) of the coating composition (B),
(2) drying the integrated pretreatment film formed from the coating composition (B), the drying being carried out preferably at PMT (peak metal temperatures) below the DMA onset temperature for the reaction of the crosslinkable constituents of the binder system (BM),
(3) applying a topcoat film (D) to the integrated pretreatment film dried as per step (2), and
(4) jointly curing the films of coating composition (B) and topcoat (D).

### DESCRIPTION OF THE INVENTION

### The Aqueous Primer Coating Composition (B)

The aqueous, preferably crosslinkable, primer coating composition (B) used to form the integrated pretreatment coat unites the properties of a pretreatment composition and of a primer. The term “integrated pretreatment coat” in the sense of the invention means that the aqueous primer coating composition (B) is applied directly to the metal surface without the performance beforehand of a corrosion-inhibiting pretreatment, such as passivation, application of a conversion coat, or phosphatizing, for example. The integrated pretreatment coat combines the passivation coat with the organic primer in a single coat. The term “metal surface” here is not to be equated with absolutely bare metal, but instead describes the surface which inevitably forms in the course of the typical handling of the metal in an atmospheric environment or else when the metal is cleaned before the integrated pretreatment coat is applied. The actual metal may, for example, also have a moisture film or a thin oxide or oxide hydrate film.

The aqueous primer coating composition (B) used to form the integrated pretreatment coat comprises at least one binder system (B), at least one filler component (BF), at least one corrosion control component (BK), and volatile constituents (BL).

Volatile constituents (BL) are defined as being those constituents of the coating composition (B) that when (B) is dried in step (2) of the method of the invention and also, in particular, during curing of coating composition (B) and topcoat (D) in step (4) of the method of the invention are removed completely from the coat system.

It is essential to the invention that the organic solvent content of the coating composition (B) is less than 15%, preferably less than 10%, more preferably less than 5%, by weight, based on the volatile constituents (BL) of the coating composition (B).

The amount of volatile constituents (BL) in the coating composition (B) may vary widely, the ratio of volatile constituents (BL) to nonvolatile constituents of the coating composition (B) being generally between 10:1 and 1:10, preferably between 5:1 and 1:5, more preferably between 4:1 and 1:4.

### The Binder System (BM)

The binder systems (BM) generally encompass the fractions in the aqueous primer coating composition (B) that are responsible for forming a film.

The coats that are applied in coil coating (the coating of metal strips) must have sufficient flexibility to withstand the shaping of the coils without suffering damage, more particularly rupturing or flaking of the coating. Accordingly, binders suitable for the binder systems (BM) preferably include units which ensure the necessary flexibility, more preferably soft segments.

The crosslinkable binder systems (BM) preferred in accordance with the invention form a polymeric network on thermal and/or photochemical curing, and encompass thermally and/or photochemically crosslinkable components. The crosslinkable components in the binder system (BM) may be of low molecular mass, oligomeric or polymeric, and in general contain at least two crosslinkable groups. The crosslinkable groups may be reactive functional groups which are able to react with groups of their own kind (“with themselves”) or with complementary reactive functional groups. In this context there is a variety of conceivable combination possibilities. The crosslinkable binder system (BM), for example, may comprise a polymeric binder which is not itself crosslinkable, and also one or more low molecular mass or oligomeric crosslinkers (V). Alternatively, the polymeric binder may include self-crosslinkable groups which are able to react with other crosslinkable groups on the polymer and/or on a crosslinker employed additionally. Particular preference is given to using oligomers or polymers that contain crosslinkable groups and that are crosslinked with one another using crosslinkers (V).

The preferred thermally crosslinkable binder systems (BM) undergo crosslinking when the film applied is heated to temperatures above room temperature, and contain preferably crosslinkable groups which react not at all or only to a very small extent at room temperature. Preference is given to using those thermally crosslinkable binder systems (BM) whose crosslinking begins at DMA onset temperatures above 60° C., preferably above 80° C., more preferably above 90° C. (as measured on a DMA IV from Rheometric Scientific with a heating rate of 2 K/min, a frequency of 1 Hz, and an amplitude of 0.2% with the measurement method “tensile mode—tensile off” in the “delta” mode, the position of the DMA onset temperature being determined in a known way by extrapolating the temperature-dependent course of E′ and/or of tan δ).

Binders suitable for the crosslinkable binder systems (BM) are preferably water-soluble or water-dispersible poly(meth)acrylates, partially hydrolyzed polyvinyl esters, polyesters, alkyd resins, polylactones, polycarbonates, polyethers, epoxy resins, epoxy resin-amine adducts, polyureas, polyamides, polyimides or polyurethanes, preference being given to water-soluble or water-dispersible crosslinkable binder systems (BM) based on polyesters, epoxy resins or epoxy resin-amine adducts, poly(meth)acrylates, and polyurethanes. Very particular preference is given to water-soluble or water-dispersible crosslinkable binder systems (BM) based on polyesters and more particularly on polyurethanes.

Suitable water-soluble or water-dispersible binder systems (BM) based on epoxides or epoxide-amine adducts are epoxy-functional polymers which are preparable in a known way by reacting epoxy-functional monomers, such as bisphenol A diglycidyl ether, bisphenol F diglycidyl ether or hexanediol diglycidyl ether, for example, with alcohols, such as bisphenol A or bisphenol F, for example. Particularly suitable soft segments are polyoxyethylene and/or polyoxypropylene segments, which are incorporated advantageously via the use of ethoxylated and/or propoxylated bisphenol A. To improve the adhesion it is possible for some of the epoxide groups of the abovementioned epoxy-functional polymers to be reacted with amines to form epoxy resin-amine adducts, more particularly with secondary amines, such as diethanolamine or N-methylbutanolamine, for example. To prepare the epoxy resins it is preferred additionally to use monomer units which as well as the free epoxide groups of the epoxy resin contain further functional groups which are able to react with groups of their own kind (“with themselves”) or with complementary, reactive functional groups, more particularly with crosslinkers (V). Such groups are, more particularly, hydroxyl groups. Suitable epoxy resins and epoxy resin-amine adducts are available commercially. Further details on epoxy resins are set out in, for example, “Epoxy Resins” in Ullmann's Encyclopedia of Industrial Chemistry, 6th Edition, 2000, Electronic Release.

Suitable water-soluble or water-dispersible binder systems (BM) based on poly(meth)acrylates are more particularly emulsion (co)polymers, more particularly anionically stabilized poly(meth)acrylate dispersions, typically obtainable from (meth)acrylic acid and/or (meth)acrylic acid derivatives, such as, more particularly, (meth)acrylic esters, such as methyl(meth)acrylate, ethyl(meth)acrylate, butyl(meth)acrylate or 2-ethylhexyl(meth)acrylate, and/or vinylaromatic monomers such as styrene, and also, where appropriate, crosslinking comonomers. The flexibility of the binder systems (BM) can be adjusted in a way which is known in principle through the proportion of “hard” monomers, i.e., monomers which form homopolymers having a comparatively high glass transition temperature, such as methyl methacrylate or styrene, to “soft” monomers, i.e., monomers which form homopolymers having a comparatively low glass transition temperature, such as butyl acrylate or 2-ethylhexyl acrylate. To prepare the poly(meth)acrylate dispersions it is further preferred to use monomers which contain functional groups which are able to react with groups of their own kind (“with themselves”) or with complementary, reactive functional groups, more particularly with crosslinkers. These groups are, more particularly, hydroxyl groups, which are incorporated into the poly(meth)acrylates using monomers such as hydroxyethyl(meth)acrylate, hydroxypropyl(meth)acrylate, hydroxybutyl(meth)acrylate or N-methylol(meth)acrylamide, or else using epoxy(meth)acrylates followed by hydrolysis. Suitable poly(meth)acrylate dispersions are available commercially.

The water-soluble or water-dispersible binder systems (BM) based on polyesters, preferred in accordance with the invention, can be synthesized in a known way from low molecular mass dicarboxylic acids and dialcohols and also, where appropriate, further monomers. Further monomers comprise, in particular, monomers having a branching effect, such as alcohols and carboxylic acids with a functionality of three or more. For the use of the binder systems (BM) in coil coating it is preferred to use polyesters having comparatively low molecular weights, preferably those having number-average molecular weights Mn between 500 and 10,000 daltons, preferably between 1,000 and 5,000 daltons. The number-average molecular weights are determined by means of gel permeation chromatography in accordance with the standards DIN 55672-1 to −3.

The hardness and the flexibility of binder systems based on polyesters can be adjusted, in a way which is known in principle, through the proportion of “hard” monomers, i.e., monomers which form homopolymers having a comparatively high glass transition temperature, to “soft” monomers, i.e., monomers which form homopolymers having a comparatively low glass transition temperature. Examples of “hard” dicarboxylic acids include aromatic dicarboxylic acids or their hydrogenated derivatives, such as isophthalic acid, phthalic acid, terephthalic acid, hexahydrophthalic acid and also their derivatives, such as, more particularly, anhydrides or esters, for example. Examples of “soft” dicarboxylic acids include, in particular, aliphatic α,ω-dicarboxylic acids having at least 4 carbon atoms, such as adipic acid, azelaic acid, sebacic acid, dodecanedioic acid or dimer fatty acids. Examples of “hard” dialcohols including ethylene glycol, 1,2-propanediol, neopentyl glycol or 1,4-cyclohexanedimethanol. Examples of “soft” dialcohols include diethylene glycol, triethylene glycol, aliphatic α,ω-dialcohols having at least 4 carbon atoms, such as 1,4-butanediol, 1,6-hexanediol, 1,8-octanediols or 1,12-dodecanediol. The preparation of the commercially available polyesters is described in, for example, the standard work Ullmanns Enzyklopädie der technischen Chemie, 3rd edition, volume 14, Urban & Schwarzenberg, Munich, Berlin, 1963, pages 80 to 89 and pages 99 to 105.

In order to establish solubility in water or dispersability in water, groups capable preferably of forming anions are incorporated into the polyester molecules; following their neutralization, these groups ensure that the polyester resin can be stably dispersed in water. Suitable groups capable of forming anions are preferably carboxyl, sulfonic acid, and phosphonic acid groups, more preferably carboxyl groups. The acid number to DIN EN ISO 3682 of the polyester resins is preferably between 10 and 100 mg KOH/g, more preferably between 20 and 60 mg KOH/g. To neutralize preferably 50 to 100 mol %, more preferably from 60 to 90 mol %, of the groups that are capable of forming anions, it is preferred likewise to use ammonia, amines and/or amino alcohols, such as di- and triethylamine, dimethylaminoethanolamine, diisopropanolamine, morpholines and/or N-alkylmorpholines, for example. Crosslinking groups used are preferably hydroxyl groups, the OH numbers to DIN EN ISO 4629 of the water-dispersible polyester being preferably between 10 and 200 and more preferably between 20 and 150.

Subsequently the polyesters thus prepared are dispersed in water, the desired solids content of the dispersion being set.

The solids content of the polyester dispersions thus prepared is preferably between 5% and 50% by weight, more preferably between 10% and 40% by weight.

The binder systems (BM) based on polyurethanes that are particularly preferred in accordance with the invention are preferably obtainable from the aforementioned polyesters as hydroxyl-functional precursors through reaction with suitable di- or polyisocyanates. The preparation of suitable polyurethanes is described in DE-A-27 36 542, for example. In order to establish solubility in water or dispersability in water, groups capable of forming anions are incorporated into the polyurethane molecules; following their neutralization, these groups ensure that the polyurethane resin can be stably dispersed in water to produce a polyurethane dispersion. Suitable groups capable of forming anions are preferably carboxyl, sulfonic acid, and phosphonic acid groups, more preferably carboxyl groups. The acid number of the water-dispersible polyurethanes to DIN EN ISO 3682 is preferably between 10 and 80 mg KOH/g, more preferably between 15 and 40 mg KOH/g. Crosslinking groups used are preferably hydroxyl groups, the OH numbers of the water-dispersible polyurethanes to DIN EN ISO 4629 being preferably between 10 and 200 and more preferably between 15 and 80. Particularly preferred water-dispersible polyurethanes are synthesized from hydroxyl-functional polyester precursors, of the kind described above, for example, which are reacted preferably with mixtures of bisisocyanato compounds, such as preferably hexamethylene diisocyanate, isophorone diisocyanate, TMXDI, 4,4′-methylenebis(cyclohexyl isocyanate), 4,4′-methylenebis(phenyl isocyanate), 1,3-bis(1-isocyanato-1-methylethyl)benzene, further diols, such as neopentyl glycol more particularly, and compounds capable of forming anions, such as 2,2-bis(hydroxymethyl)propionic acid more particularly, to give the polyurethane.

Optionally the polyurethanes can be synthesized in branched form through the proportional use of polyols, preferably triols, and more preferably trimethylolpropane.

With very particular preference the reaction of the aforementioned units is carried out with a ratio of the isocyanate groups to hydroxyl groups of 1.4:1.005, preferably between 1.3:1.05.

In a further, especially preferred embodiment of the invention, at least 25, preferably at least 50, mol % of the unreacted isocyanate groups are reacted with low-volatility amines and/or amino alcohols, such as, more particularly, triethanolamine, diethanolamine or methylethanolamine, and at the same time the amines and/or amino alcohols neutralize some of the groups capable of forming anions.

The possibly remaining unreacted isocyanate groups are reacted preferably with blocking agents, such as, more particularly, monofunctional alcohols, preferably propanols or butanols, until the free isocyanate group content is less than 0.1%, preferably less than 0.05%. In the final step of the preparation of the polyurethane dispersion it is preferred, in order to neutralize preferably 50 to 100 mol %, more preferably from 60 to 90 mol %, of the groups capable of forming anions, to use ammonia, amines and/or amino alcohols, such as di- and triethylamine, dimethylethanolamine, diisopropanolamine, morpholines and/or N-alkylmorpholines, for example, particular preference being given to dimethylethanolamine.

Subsequently the thus-prepared polyurethanes are dispersed in water, the desired solids content of the dispersion being set.

The solids content of the thus-prepared polyurethane dispersions is preferably between 5% and 50% by weight, more preferably between 10% and 40% by weight.

In one particularly preferred embodiment of the invention at least one of the above-described components of the binder system, more particularly the above-described polyester and polyurethane components, is prepared in the particularly low-solvent form of an aqueous dispersion; the solvent is removed in a way which is known to the skilled worker, more particularly by distillation, more particularly after the binder has been prepared and before it is dispersed in water. With preference, the aqueous dispersion of the binder component, more particularly the polyester dispersions and polyurethane dispersions, is adjusted to a residual solvent content of less than 1.5% by weight, more preferably of less than 1% by weight, and very preferably of less than 0.5% by weight, based on the volatile constituents of the dispersion.

The preferably water-soluble or water-dispersible crosslinkers (V) for the thermal crosslinking of the aforementioned polymers are known to the skilled worker.

Examples of suitable crosslinkers (V) for the crosslinking of the epoxy-functional polymers are polyamines, such as preferably diethylenetriamine, amine adducts or polyaminoamides. Particularly preferred for epoxy-functional polymers are crosslinkers (V) based on carboxylic anhydrides, melamine resins, and optionally blocked polyisocyanates.

In particular, in the context of the present invention, low-solvent crosslinkers (V) are used, with residual solvent contents of less than 1.0%, more preferably less than 0.5%, and very preferably of less than 0.2%, by weight, based on the volatile constituents of the crosslinkers.

Particularly preferred crosslinkers (V) for the crosslinking of the preferred hydroxyl-containing polymers are melamine resins, amino resins and—preferably blocked—polyisocyanates.

Very particular preference for the crosslinking of the preferred hydroxyl-containing polymers is given to melamine derivatives, such as hexabutoxymethylmelamine and more particularly the highly reactive hexamethoxymethylmelamine, and/or to optionally modified amino resins. Crosslinkers (V) of this kind are available commercially (in the form, for example, of Luwipal® from BASF AG). In particular, in the context of the present invention, low-solvent melamine resins are used with residual solvent contents of less than 1.0%, more preferably of less than 0.5%, and very preferably of less than 0.2%, by weight, based on the volatile constituents of the melamine resin preparation.

The preferably blocked polyisocyanates suitable as crosslinkers (V) for the preferred hydroxyl-containing polymers are, more particularly, oligomers of diisocyanates, such as trimethylene diisocyanates, tetramethylene diisocyanate, pentamethylene diisocyanate, hexamethylene diisocyanate, heptamethylene diisocyanate, ethylethylene diisocyanate, trimethylhexane diisocyanate or acyclic aliphatic diisocyanates which contain a cyclic group in their carbon chain, such as diisocyanates derived from dimer fatty acids, of the kind marketed by Henkel under the trade name DDI 1410 and described in patents WO 97/49745 and WO 97/49747. The latter are included among acyclic aliphatic diisocyanates in the context of the present invention on account of their two isocyanate groups attached exclusively to alkyl groups, in spite of their cyclic groups. Of the above-mentioned diisocyanates, hexamethylene diisocyanate is used with particular preference. It is preferred to use oligomers which contain isocyanurate, urea, urethane, biuret, uretedione, iminooxadiazinedione, carbodiimide and/or allophanate groups.

In the context of the blocking of the polyisocyanates, the isocyanate group is reacted with a blocking agent, which is eliminated again on heating to higher temperatures. Examples of suitable blocking agents are described in DE-A-199 14 896, columns 12 and 13, for example.

To accelerate the crosslinking it is preferred to add suitable catalysts in a known way.

In another embodiment of the invention the crosslinking in the binder system (BM) may also take place photochemically. The term “photochemical crosslinking” is intended to encompass crosslinking with all kinds of high-energy radiation, such as UV, VIS, NIR or electron beams, for example.

Photochemically crosslinkable, water-soluble or water-dispersible binder systems (BM) generally comprise oligomeric or polymeric compounds having photochemically crosslinkable groups and also, if desired, reactive diluents, generally monomeric compounds. Reactive diluents have a lower viscosity than the oligomeric or polymeric compounds. Furthermore, in general, one or more photoinitiators are necessary for photochemical crosslinking.

Examples of photochemically crosslinkable binder systems (BM) encompass water-soluble or water-dispersible polyfunctional (meth)acrylates, urethane(meth)acrylates, polyester(meth)acrylates, epoxy(meth)acrylates, carbonate(meth)acrylates, and polyether(meth)acrylates, where appropriate in combination with reactive diluents such as methyl(meth)acrylate, butanediol di(meth)acrylate, hexanediol di(meth)acrylate or trimethylolpropane tri(meth)acrylate. Further details of suitable radiation-curable binders are to be found in WO-A-2005/080484, pages 3 to 15, for example. Suitable photoinitiators are found in the same text on pages 18 and 19. Furthermore, for the performance of the present invention, it is also possible to use binder systems (BM) which can be cured in combination thermally and photochemically (dual-cure systems).

Based on the nonvolatile fractions in the binder system (BM), the fraction of the crosslinker (V) as a proportion of the binder system (BM) is preferably between 5% and 60% by weight, more preferably between 7.5% and 50% by weight, based on the binder system (BM).

In a further embodiment of the invention the binder systems (BM) are physically drying—in other words, when the coating film is formed, which is realized preferably through drying of the coating composition (B), in other words by withdrawal of the solvent, the binder systems (BM) crosslink not at all or only to a very minor extent. Preference for the physically drying systems is given to using the above-recited water-soluble or water-dispersible binder systems (BM), more particularly the above-described binder systems (BM) based on polyurethane, with the crosslinkers (V), and more particularly further crosslinking-assisting components, such as catalysts or initiators, generally being absent from the coating composition (B).

The coating composition (B) used in accordance with the invention contains preferably 10% to 90%, more preferably 15% to 85%, more particularly 20 to 80%, by weight of the binder system (BM), based on the nonvolatile constituents of the coating composition (B).

### The Filler Component (BF)

The preferably inorganic filler component (BF) used in accordance with the invention preferably comprises conventional fillers, inorganic color and/or effect pigments and/or conductive pigments.

Conventional fillers, serving more particularly to compensate unevennesses in the substrate and/or to increase the impact strength of the coat produced from the coating composition (B), are preferably chalk, hydroxides such as aluminum or magnesium hydroxides, and phyllosilicates such as talc or kaolin, particular preference being given to talc.

Color and/or effect pigments used are preferably inorganic pigments, such as white pigments and black pigments more particularly. Preferred white pigments are silicas, aluminas, and, in particular, titanium oxides, and also barium sulfate. Preferred black pigments are iron oxides and more particularly graphite and carbon blacks.

Conductive pigments used are preferably phosphides, vanadium carbide, titanium nitride, and molybdenum sulfide. Additives of this kind serve, for example, to improve the weldability of the coat formed from the coating composition (B). Preferred conductive pigments used are metal phosphides of Zn, Al, Si, Mn, Cr, Ni or, in particular, Fe, as described in WO 03/062327 A1, for example. Zinc dust is used with particular preference as a conductive pigment.

The fillers present in the filler component (BF) preferably have average particle diameters which do not exceed the thickness of the cured integrated pretreatment coat. The upper particle size limit on the filler component (BF) as measured in accordance with EN ISO 1524:2002 is preferably less than 15 μm, more preferably less than 12 μm, and in particular less than 10 μm.

More preferably, the filler component (BF) has residual solvent contents of less then 1% by weight, in particular of less than 0.5% by weight, in each case based on (BF). Most preferably, the filler component (BF) is solvent-free.

The coating composition (B) used in accordance with the invention contains preferably 5% to 80%, more preferably 10% to 70%, and in particular 15% to 65% by weight, based on the nonvolatile constituents of the coating composition (B), of fillers (BF).

### The Corrosion Control Component (BK)

The corrosion control component (BK) used in accordance with the invention comprises preferably inorganic anticorrosion pigments, such as, more particularly, aluminum phosphate, zinc phosphate, zinc aluminum phosphate, molybdenum oxide, zinc molybdate, calcium zinc molybdate, zinc metaborate or barium metaborate monohydrate. In one particularly preferred embodiment of the invention such anticorrosion pigments are used in combination with amorphous silica modified with metal ions. The metal ions are preferably selected from the group consisting of alkali metal ions, alkaline earth metal ions, lanthanide metal ions, and also zinc ions and aluminum ions, with calcium ions being particularly preferred. Amorphous silica modified with calcium ions can be acquired as a commercial product under the brand name Shieldex® (from Grace GmbH & Co. KG).

In addition, as a constituent of the anticorrosion pigment preparations, it is also possible to use dimeric, oligomeric or polymeric alkoxides of aluminum or titanium, where appropriate in the form of adducts with compounds containing phosphorus, as described in WO 03/062328 A1.

The anticorrosion pigments present in the corrosion control component (BK) preferably have average particle diameters which do not exceed the thickness of the cured integrated pretreatment coat. The upper particle size limit on the anticorrosion pigments (BK) as measured in accordance with EN ISO 1524:2002 is preferably less than 15 μm, more preferably less than 12 μm, and in particular less than 10 μm.

More preferably, the corrosion control component (BK) has residual solvent contents of less than 1% by weight, in particular of less than 0.5% by weight, in each case based on (BK).

Furthermore, instead of or in addition to the abovementioned inorganic anticorrosion pigments, it is also possible for organic, low molecular mass and/or polymeric corrosion inhibitors to be present in the corrosion control component (BK). Organic corrosion inhibitors used are preferably copolymers or unsaturated dicarboxylic acid and olefins, of the kind described in WO 2006/079628 A1, for example, and, with very particular preference, copolymers of monomers with nitrogen heterocycles, monomers with acid groups, and vinylaromatic monomers, as described in WO 2007/125038 A1. With very particular preference the aqueous dispersions of the copolymers described in WO 2007/125038 are adjusted in a further preparation step to residual solvent contents of less than 1%, preferably of less than 0.5%, and more particularly of less than 0.2%, by weight, based, in each case, on the volatile constituents of the aqueous dispersion.

With very particular preference the corrosion control component (BK) comprises at least one combination of organic and inorganic corrosion inhibitors with, in particular, the present combination having residual solvent contents of less than 1% by weight, preferably of less than 0.5% by weight, based, in each case, on the volatile constituents of the corrosion control components (BK).

The coating composition (B) used in accordance with the invention contains preferably 1% to 50%, more preferably 2% to 40%, and more particularly 3% to 35% by weight, based on the nonvolatile constituents of the coating composition (B), of the corrosion control component (BK).

### The Further Components of the Coating Composition (B)

As a further component the coating composition of the invention comprises water and, where appropriate, preferably water-compatible organic solvents as additional volatile constituents (BL) which are removed during the drying and more particularly the curing of the coating composition (B).

From among the solvents possible in principle, the skilled worker makes an appropriate selection according to the operating conditions and the nature of the components employed. Examples of preferred organic solvents, which are preferably compatible with water, include ethers, polyethers, such as polyethylene glycol, ether alcohols, such as butyl glycol or methoxypropanol, ether glycol acetates, such as butyl glycol acetate, ketones, such as acetone and methyl ethyl ketone, and alcohols, such as methanol, ethanol or propanol. In addition in minor amounts it is possible for hydrophobic solvents, such as, more particularly, petroleum fractions and aromatic fractions, to be used, in which case such solvents are used more as additives, for the purpose of controlling specific coating properties.

Beyond the aforementioned components the coating composition (B) may comprise one or more adjuvants. Adjuvants of this kind are used to fine-tune the properties of the coating composition (B) and/or of the coat produced from the coating composition (B). The adjuvants are generally present at up to 30% by weight, based on the coating composition, preferably up to 25% by weight, more particularly up to 20% by weight, in the coating composition (B).

Examples of suitable adjuvants are rheological assistants, organic color and/or effect pigments, UV absorbers, light stabilizers, free-radical scavengers, free-radical polymerization initiators, thermal crosslinking catalysts, photoinitiators, slip additives, polymerization inhibitors, defoamers, emulsifiers, degassing agents, wetting agents, dispersants, adhesion promoters, leveling agents, film-forming assistants, thickeners, flame retardants, siccatives, antiskinning agents, waxes, and matting agents, of the kind known, for example, from the textbook “Lackadditive” [Additives for Coatings] by Johan Bieleman, Wiley-VCH, Weinheim, N.Y., 1998. It is preferred to use adjuvants with a low residual solvent content in the preparation of the adjuvants, such as, more particularly, low-solvent dispersants, low-solvent flow control agents, and low-solvent defoamers, which more particularly have residual solvent contents of less than 1%, preferably of less than 0.8%, and more particularly of less than 0.5%, by weight, based, in each case, on the volatile phase of the adjuvant.

The coating composition (B) is prepared by intensely mixing the components with the solvent. Suitable mixing and dispersing assemblies are known to the skilled worker.

### The Steps of the Method of the Invention

In step (1) of the method of the invention the coating composition (B) is applied to the metal surface of the coil.

The metal surface may where appropriate be cleaned beforehand. Where step (1) of the method takes place immediately after a metallic surface treatment, such as an electrolytic galvanization or hot-dip galvanization of the metal surface, for example, then the coating composition (B) can generally be applied to the coil without preliminary cleaning. Where the coils to be coated are stored and/or transported before being coated with the coating composition (B), they generally carry a coating of anticorrosion oils or else are otherwise contaminated, and so the coil needs to be cleaned before step (1) of the method. Cleaning may take place by techniques known to the skilled worker, with typical cleaning agents.

Application of the coating composition (B) to the coil may take place by spraying, pouring, or, preferably, rolling.

In the case of the preferred roll coating, the rotating pick-up roll dips into a reservoir of the coating composition (B) and in this way picks up the coating composition (B) to be applied. This composition is transferred from the pick-up roll, directly or via at least one transfer roll, to the rotating application roll. This roll transfers the coating composition (B) onto the coil, with application taking place either by the forward roller coating process (co-directional transfer) or by counter-directional transfer or the reverse roller coating process.

Both techniques are possible for the method of the invention, the forward roller coating process (co-directional transfer) being preferred. The coil speed is preferably between 80 and 150 m/min, more preferably between 100 and 140 m/min. The application roll preferably has a rotational speed which is 110 to 125% of the coil speed, and the pick-up roll preferably has a rotational speed which is 15 to 40% of the coil speed.

The coating composition (B) can, in another embodiment of the invention, be pumped directly into a gap (nip) between two rolls, this also being referred to as the nip-feed method.

The speed of the coil is chosen by the skilled worker in accordance with the drying conditions for the coating composition (B) in step (2). Generally speaking, coil speeds of 20 to 200 m/min, preferably 80 to 150 m/min, more preferably 100 to 140 m/min, have been found appropriate, it being also necessary for the coil speed to be determined by the abovementioned application methods.

For the drying of the film of coating composition (B) formed on the coil, in other words removing the volatile constituents (BL) of the coating composition (B), the coil coated as per step (1) is heated by means of a suitable device. Heating may take place by convective heat transfer, irradiation with near or far infrared radiation, and/or, in the case of appropriate metal substrates, more particularly iron, by means of electrical induction. The solvent can also be removed by contacting with a flow of gas, in which case a combination with the above-described heating is possible.

In accordance with the invention it is preferred for the drying of the film of coating composition (B) formed on the coil to be carried out such that the film after drying still has a residual volatile constituent (BL) content of not more than 10% by weight, based on the coating composition (B), preferably of not more than 8% by weight, more preferably of not more than 6% by weight. The determination of the residual volatile constituents (BL) content of the coating composition takes place by known methods, preferably by means of gas chromatography, more preferably in combination with thermogravimetry.

The drying of the coating composition is carried out preferably at peak temperatures occurring on the metal (peak metal temperature (PMT)), which can be determined, for example, by noncontact infrared measurement or using temperature indicator strips) of 40 to 120° C., preferably between 50 and 110° C., more preferably between 60 and 100° C., the speed of the coil and hence the residence time in the drying region of the coil-coating line being adjusted, in a manner known to the skilled worker, in such a way that the inventively preferred residual volatile constituents (BL) content is set in the film formed from the coating composition (B) on departure from the drying region.

With particular preference the drying of the coating composition (B) is carried out at PMT (peak metal temperatures) below the DMA onset temperature for the reaction of the crosslinkable constituents in the coating composition (B) (measured by a DMA IV from Rheometric Scientific with a heating rate of 2 K/min, a frequency of 1 Hz, and an amplitude of 0.2%, using the measurement method “tensile mode—tensile off” in the “delta” mode, the position of the DMA onset temperature being determined in a known way by extrapolation of the temperature-dependent course of E′ and/or of tan δ). With very particular preference the drying is carried out at PMT which are 5 K, more particularly 10 K, below the DMA onset temperature for the reaction of the crosslinkable constituents in the coating composition (B).

For laboratory simulation of the application of the coating composition (B) in a coil-coating process, the coating composition (B) is applied, preferably using coating rods, to plates of the substrate to be coated, in a wet film thickness comparable with that of the coil coating. The laboratory simulation of the drying of the coating composition (B) in the coil-coating process is carried out preferably in a forced-air oven, with PMT (peak metal temperatures) comparable with the coil coating being set.

The thickness of the dried film of coating composition (B) produced as per step (2) of the method is generally between 1 and 15 μm, preferably between 2 and 12 μm, more preferably between 3 and 10 μm.

Between steps (2) and (3) of the method the coil provided with the dried film of coating composition (B) can be rolled up again and the further coat or coats can be applied only at a later point in time.

In step (3) of the method of the invention one or more topcoat materials (D) are applied to the dried film of coating composition (B) produced as per step (2) of the method, suitability as topcoat materials (D) being possessed in principle by all coating compositions that are suitable for coil coatings.

The topcoat material (D) may be applied by spraying, pouring or, preferably, by the above-described roller application. Preferably a pigmented topcoat material (D) with high flexibility is applied that provides not only coloring but also protection against mechanical exposure and also against effects of weathering on the coated coil. Topcoat materials (D) of this kind are described in EP-A1-1 335 945 or EP-A1-1 556 451, for example. In a further preferred embodiment of the invention the topcoat materials (D) may comprise a two-coat system made up of a coloring base coat and a final clear coat. Two-coat topcoat systems of this kind that are suitable for coating coils are described in DE-A-100 59 853 and in WO-A-2005/016985, for example.

In step (4) of the method of the invention the film of coating composition (B) applied and dried in step (2) of the method is cured, i.e., crosslinked, jointly with the topcoat (D) film applied in step (3) of the method, the residual volatile components (BL) from the dried film of the coating composition (B) and also the solvent from the topcoat material (D) being jointly removed.

Crosslinking is governed by the nature of the binders (BM) employed in the coating composition (B) and also of the binders employed in the topcoat film (D), and may take place thermally and/or, where appropriate, photochemically.

In the case of the inventively preferred thermal crosslinking the coil coated as per steps (1) to (3) of the method is heated by means of a suitable device. Heating may take place by irradiation with near or far infrared radiation, by electrical induction in the case of suitable metal substrates, more particularly iron and, preferably, by convective heat transfer. The removal of the solvent can also be accomplished by contacting with a stream of gas, in which case a combination with the above-described heating is possible.

The temperature required for the crosslinking is governed more particularly by the binders employed in the coating composition (B) and in the topcoat film (D). Preferably the crosslinking is carried out at peak temperatures encountered on the metal (PMT) of at least 80° C., more preferably at least 100° C., and very preferably at least 120° C. More particularly the crosslinking is performed at PMT values between 120 and 300° C., preferably between 140 and 280° C., and more preferably between 150 and 260° C.

The speed of the coil and hence the residence time in the oven region of the coil-coating line is preferably adjusted, in a manner known to the skilled worker, in such a way that crosslinking in the film formed from the coating composition (B) and in the film formed from the topcoat material (D) is substantially complete on departure from the oven region. The duration for the crosslinking is preferably 10 s to 2 min. Where, for example, ovens with convective heat transfer are employed, forced-air ovens with a length of around 30 to 50 m are required in the case of the preferred coil speeds. The forced-air temperature in this case is of course higher than the PMT and can be up to 350° C.

Photochemical crosslinking takes place in general with actinic radiation, by which is meant, below, near infrared, visible light (VIS radiation), UV radiation, X-rays, or particulate radiation, such as electron beams. For the photochemical crosslinking it is preferred to use UV/VIS radiation. Irradiation may be carried out where appropriate in the absence of oxygen, such as under an inert-gas atmosphere, for example. Photochemical crosslinking may take place under standard temperature conditions, especially when both coating composition (B) and topcoat material (D) crosslink exclusively photochemically. In general the photochemical crosslinking takes place at elevated temperatures, of between 40 and 200° C. for example, more particularly when one of the coating compositions (B) and (D) crosslinks photochemically and the other crosslinks thermally, or when one or both of the coating compositions (B) and (D) crosslink photochemically and thermally.

The thickness of the coat system produced as per step (4) of the method, comprising the cured coat based on the coating composition (B) and the cured coat based on the topcoat material (D), is generally between 2 and 60 μm, preferably between 4 and 50 μm, more preferably between 6 and 40 μm.

For laboratory simulation of the application of the topcoat material (D) in the coil-coating process, the topcoat material (D) is applied, preferably using coating rods, to the dried coating composition (B), in a wet film thickness comparable with that of the coil coating. The laboratory simulation of the joint curing of the coating composition (B) and of the topcoat material (D) in the coil-coating process is carried out preferably in forced-air ovens, with PMT (peak metal temperatures) comparable with coil coating being set.

The coat systems produced by the method of the invention may be applied more particularly to the surface of iron, steel, zinc or zinc alloys, such as zinc aluminum alloys, for example, such as Galvalume® and Galfan®, or zinc magnesium alloys, magnesium or magnesium alloys, or aluminum or aluminum alloys.

Coils provided with the coat system produced by the method of the invention may be processed by means, for example, of cutting, forming, welding and/or joining, to form shaped metallic parts. The invention hence also provides shaped articles which have been produced with the inventively produced coils. The term “shaped article” is intended to encompass not only coated metal panels, foils or coils but also the metallic components obtained from them.

Such components are more particularly those that can be used for paneling, facing or lining. Examples include automobile bodies or parts thereof, truck bodies, frames for two-wheelers such as motorcycles or pedal cycles, or parts for such vehicles, such as fairings or panels, casings for household appliances such as washing machines, dishwashers, laundry driers, gas and electric ovens, microwave ovens, freezers or refrigerators, for example, paneling for technical instruments or installations such as machines, switching cabinets, computer housings or the like, for example, structural elements in the architectural sector, such as wall parts, facing elements, ceiling elements, window profiles, door profiles or partitions, furniture made from metallic materials, such as metal cupboards, metal shelves, parts of furniture, or else fittings. The components may also be hollow articles for storage of liquids or other substances, such as, for example, tins, cans or tanks.

The examples which follow are intended to illustrate the invention.

### EXAMPLES

### Preparation Example 1

### Preparation of a Low-Solvent Polyurethane Dispersion (PUD)

Preparation of the Hydroxyl-Containing Polyester Diol Prepolymer: 1158.2 g of dimer fatty acid Pripol® 1012 (Uniqema), 644 g of hexanediol, and 342.9 g of isophthalic acid are weighed out with addition of 22.8 g of cyclohexane into a stirred tank equipped with a packed column and water separator and this initial charge is heated to 220° C. under a nitrogen atmosphere. At an acid number less than 4 mg KOH/g and a viscosity of 5-7 dPas (76% dilution in xylene), reduced pressure is applied at 150° C. and volatile constituents are removed. The polyester is cooled, diluted with methyl ethyl ketone, and adjusted to a solids content of 73%.

### Preparation of the Polyurethane Dispersion:

1699.6 g of the polyester diol prepolymer in solution in methyl ethyl ketone, 110.8 g of dimethylpropionic acid, 22.7 g of neopentyl glycol, 597.6 g of dicyclohexylmethane diisocyanate (Desmodur® W from Bayer AG), and 522 g of methyl ethyl ketone are charged to a stirred tank and heated with stirring at 78° C. in a nitrogen atmosphere. When the isocyanate group content is a constant 1.3%, based on the solids content, corresponding to a ratio of isocyanate groups to hydroxyl groups of around 1.18:1, 64 g of triethanolamine are added. The reaction mixture is stirred until it has an isocyanate group content of 0.3%, based on the solids content, corresponding to a conversion of around 75 mol % of the originally unreacted isocyanate groups. Thereafter the remaining isocyanate groups are reacted with 51.8 g of n-butanol and the reaction is completed by stirring at 78° C. for one hour more. Following the reaction the free isocyanate group content is <0.05%. After 58.1 g of dimethylethanolamine have been added, 3873.5 g of distilled water are added dropwise over the course of 90 min and the resulting dispersion is stirred for one hour more. The polyurethane thus prepared has an OH number to DIN EN ISO 4629 of 37 mg KOH/g, an acid number to DIN EN ISO 3682 of 23 mg KOH/g, and a degree of neutralization of 74 mol % of the groups capable of forming anions.

To lower the residual solvent content the volatile constituents are removed under reduced pressure at 78° C. until the refractive index of the distillate is less than 1.335 and the methyl ethyl ketone content detected by gas chromatography is less than 0.3% by weight, based on the reactor mixture. The solids content of the resulting dispersion is adjusted to 30% with distilled water. The polyurethane dispersion has a low viscosity, a pH of 8-9, and a residual solvent content by gas chromatography of 0.35% by weight, based on the volatile constituents of the dispersion.

### Comparative Example 1

### Preparation of the Polyurethane Dispersion (PUD') without Optimization of the Residual Solvent

The polyurethane dispersion is prepared as per preparation example 1 but without the concluding step of lowering the residual solvent content. The polyurethane dispersion has a low viscosity, a pH of 8-9, and a residual solvent content of 1.04% by weight, based on the volatile constituents of the dispersion.

### Inventive Example 2

### Preparation of the Inventive Low-Solvent Coating Composition (B)

In a suitable stirring vessel, in the order stated, 20 parts by weight of the polyurethane dispersion (PUD) as per preparation example 1, 7.1 parts by weight of a low-solvent dispersing additive (residual organic solvent content<0.02% by weight, based on the volatile constituents of the dispersing additive), 1.7 parts by weight of a conventional flow control agent with defoamer effect (residual organic solvent content 0.21% by weight, based on the volatile constituents of the flow control agent), 0.2 part by weight of a silicate, and 24.2 parts by weight of a solvent-free mixture consisting of inorganic anticorrosion pigments, known to the skilled worker, and fillers, are mixed and the mixture is subjected to preliminary dispersing using a dissolver for ten minutes. The resulting mixture is transferred to a bead mill with cooling jacket and is mixed with 1.8-2.2 mm SAZ glass beads. The millbase is ground for 45 minutes, the temperature being held at a maximum of 50° C. by cooling. Subsequently the millbase is separated from the glass beads. The upper particle size limit on the fillers and the anticorrosion pigments, to EN ISO 1524:2002, is less than 10 μm after grinding.

The millbase is admixed with stirring, the temperature being held at not more than 60° C. by cooling, and in the stated order, with 29.5 parts by weight of the polyurethane dispersion (PUD) of preparation example 1, 4.6 parts by weight of a low-solvent melamine resin crosslinker (residual content of organic solvent 0.04% by weight, based on the volatile constituents of the melamine resin), 0.9 part by weight of a low-solvent defoamer (residual organic solvent content<0.02% by weight, based on the volatile constituents of the defoamer), 1.4 parts by weight of an acidic catalyst from the class of blocked aromatic sulfonic acids, 1 part by weight of a conventional flow control agent with defoamer effect (residual organic solvent content 0.21% by weight, based on the volatile constituents of the flow control agent), and 1 part by weight of a further, acrylate-based flow control assistant (residual organic solvent content 0.45% by weight, based on the volatile constituents of the flow control agent).

In a concluding step, 8.4 parts by weight of an aqueous dispersion of a copolymer of 45% by weight N-vinylimidazole, 25% by weight of vinylphosphonic acid, and 30% by weight of styrene, prepared according to example 1 of WO-A-2007/125038, are added, the residual solvent fraction having been adjusted in a further preparation step to <0.1% by weight, based on the volatile constituents of the dispersion of the copolymer.

The fraction of residual solvent in the aqueous coating composition (B) of the invention is 2.2% by weight, based on the volatile constituents (BL) of the coating composition (B).

### Comparative Example 2

### Preparation of the Coating Composition (B′) without Optimization of the Residual Solvent Content

In a suitable stirring vessel, in the order stated, 20 parts by weight of the polyurethane dispersion (PUD) as per comparative example 1, 4.2 parts by weight of a conventional dispersing additive (residual organic solvent content 2.0% by weight, based on the volatile constituents of the dispersing additive), 1.6 parts by weight of a conventional flow control agent with defoamer effect (residual organic solvent content 0.21% by weight, based on the volatile constituents of the flow control agent), 0.2 part by weight of a silicate, and 24.0 parts by weight of a solvent-free mixture consisting of inorganic anticorrosion pigments, known to the skilled worker, and fillers, are mixed and the mixture is subjected to preliminary dispersing using a dissolver for ten minutes. The resulting mixture is transferred to a bead mill with cooling jacket and is mixed with 1.8-2.2 mm SAZ glass beads. The millbase is ground for 45 minutes, the temperature being held at a maximum of 50° C. by cooling. Subsequently the millbase is separated from the glass beads. The upper particle size limit on the fillers and the anticorrosion pigments, to EN ISO 1524:2002, is less than 10 μm after grinding.

The millbase is admixed with stirring, the temperature being held at not more than 60° C. by cooling, and in the stated order, with 26.6 parts by weight of the polyurethane dispersion (PUD) of preparation example 1, 4.6 parts by weight of a conventional melamine resin crosslinker (residual content of organic solvent 1.0% by weight, based on the volatile constituents of the melamine resin), 0.9 part by weight of a low-solvent defoamer (residual organic solvent content<0.02% by weight, based on the volatile constituents of the defoamer), 2.9 parts by weight of a conventional acidic catalyst from the class of blocked aromatic sulfonic acids (residual organic solvent content 1.65% by weight, based on the volatile constituents of the defoamer), 1 part by weight of a conventional flow control agent with defoamer effect (residual organic solvent content 0.21% by weight, based on the volatile constituents of the flow control agent), and 1 part by weight of a further, acrylate-based flow control assistant (residual organic solvent content 0.45% by weight, based on the volatile constituents of the flow control agent).

In a concluding step, 10.7 parts by weight of an aqueous dispersion of a copolymer of 45% by weight N-vinylimidazole, 25% by weight of vinylphosphonic acid, and 30% by weight of styrene, prepared according to example 1 of WO-A-2007/125038, are added (residual organic solvent content 3.87% by weight, based on the volatile constituents of the copolymer). To set the required processing viscosity a further 2.3 parts by weight of fully deionized water are added.

The fraction of residual solvent in the aqueous coating composition (B′) as per comparative example 2 is 21.7% by weight, based on the volatile constituents (BL′) of the coating composition (B′).

### Example 3

### Application of the Coating Composition by the Method of the Invention

The coating tests are carried out using galvanized steel sheets of type Z, thickness 0.9 mm (OEHDG, Chemetall). These sheets are cleaned beforehand by known techniques. The coating compositions (B) and (B′) described were applied using coating rods at a wet film thickness such that drying of the coatings resulted in a dry film thickness of 5 μm. The coating compositions (B) and (B′) were dried in a forced-air oven from Hofmann at a forced-air temperature of 185° C. and a fan power of 10% for 22 seconds, giving a PMT of 88° C.

The DMA onset temperature (measured on a DMA IV from Rheometric Scientific with a heating rate of 2 K/min, a frequency of 1 Hz, and an amplitude of 0.2%, with the measurement method “tensile mode—tensile off” in the “delta” mode, the position of the DMA onset temperature being determined in a known way by extrapolation of the temperature-dependent course of E′) for the reaction of the crosslinkable constituents in the coating composition (B) or (B′) is 102° C.

The volatiles content of the dried film of coating composition (B) or (B′) is 4.5% by weight, based on the dried film.

The film produced by the method of the invention with the low-solvent coating composition (B) in step (2) exhibits particularly good leveling even at low temperatures and its overcoatability is very good in spite of no chemical curing having taken place (table 1).

In comparison, a film produced with the higher-solvent coating composition (B′) in step (2) exhibits distinct surface roughness and hence pour leveling, and the overcoatability is significantly impaired (table 1).

Subsequently a topcoat material (D) of type Polyceram® PH from BASF Coatings AG is applied using coating rods in a wet film thickness such that drying of the coatings in the system comprising primer film (B) or (B′) and topcoat film (D) results in a dry film thickness of 25 μm. The system comprising primer film (B) or (B′) and topcoat (D) is baked in a tunnel oven from Hedinair at a forced-air temperature of 365° C. and such a belt speed that it results in a PMT of 243° C.

The following properties that are critical for coil coatings are determined on the thus produced systems of coating composition (B) or (B′) and topcoat (D) (table 1).

### MEK Test:

Procedure as per EN ISO 13523-11. This method characterizes the resistance of coating films towards exposure to solvents such as methyl ethyl ketone.

It involves rubbing a cotton compress soaked with methyl ethyl ketone over the coating film under a defined applied weight. The number of double rubs until damage to the coating film first becomes visible is the MEK value to be reported.

T-Bend Test:

Procedure as per DIN ISO 1519. The test method serves for determining the cracking of coatings under bending stress at room temperature (20° C.). Test strips are cut and are prebent around edges by 135°.

After the bending around edges, stencils of varying thickness are placed between the blades of the preliminary bending. The blades are then pressed together with a defined force. The extent of the shaping is reported by means of the T value. The relationship which applies here is as follows:

T=r/d

r=radius in cm

d=thickness of metal sheet in cm

The operation commences at 0 T and the bending radius is increased until cracks are no longer apparent. This figure is the T-bend value to be reported.

### Tape Test:

Procedure as per DIN ISO 1519. The test method serves for determining the adhesion of coatings under bending stress at room temperature (20° C.).

Test strips are cut and are prebent around edges by 135°. After the bending around edges, stencils of varying thickness are placed between the blades of the preliminary bending. The blades are then pressed together with a defined force. The extent of the shaping is reported by means of the T value. The relationship which applies here is as follows:

T=r/d

r=radius in cm

d=thickness of metal sheet in cm

The operation commences at 0 T and the bending radius is increased until coating material can no longer be torn off with an adhesive tape (Tesa® 4104). This figure is the tape value to be reported.

### Corrosion Control Test:

In order to test the corrosion inhibition effect of the coatings of the invention, the galvanized steel sheets were subjected to a salt spray test to DIN 50021 for 360 h.

After the end of corrosion exposure, the test sheets were assessed by measuring the damaged area of coating (propensity for subfilm corrosion) at the edge and at the scribe mark (in accordance with DIN 55928).

The table below contains the results of all of the investigations referred to above.

TABLE 1

| | (B′) with drying | (B) with drying |
|---|---|---|
| | before application of | before application |
| | the topcoat film (not | of the topcoat film |
| Coating composition | solvent-optimized) | (inventive) |
| Leveling of the coating | Rough, streaky | Very smooth film, |
| formed from coating | | no visible or |
| composition (B) or (B′) | | tangible defects |
| Overcoatability of the film | Limited owing to | Very good |
| dried as per step (2) | the surface | |
| | roughness | |
| MEK test on | 72 | >100 |
| primer/topcoat system | | |
| baked as per step (4) | | |
| [double rubs] | | |
| T-bend test on | 2.5 | 2.0 |
| primer/topcoat system | | |
| baked as per step (4) | | |
| [T value] | | |
| Tape test on | 1.0 | 0.5 |
| primer/topcoat system | | |
| baked as per step (4) | | |
| [T value] | | |
| Corrosion test on | >20 | 2.5 |
| primer/topcoat system | | |
| baked as per step (4) | | |
| (360 h SS): left-hand edge | | |
| [mm subfilm corrosion] | | |
| Right-hand edge [mm | >20 | 2.5 |
| subfilm corrosion] | | |
| Scribe mark [mm subfilm | >20 | 0.5 |
| corrosion] | | |

The solvent resistance in the MEK test on the system comprising primer and topcoat, baked as per step (4) of the method, is significantly higher when using the solvent-optimized coating composition (B) than in the case of the higher-solvent-content coating composition (B′).

Also observable are a drastically improved corrosion resistance on the part of the system comprising primer and topcoat, baked as per step (4) of the method, and improved behavior in the T-bend test and in the tape test when using the solvent-optimized coating composition (B), in comparison to the use of the higher-solvent-content coating composition (B′).

1. A method of coating a metal coil, comprising:
(1) applying an aqueous primer coating composition (B) to at least one metal surface of the coil to form an integrated pretreatment film, the aqueous primer coating composition (B) comprising
at least one crosslinkable binder system (BM) comprising one or more components or constituents,
at least one filler component (BF),
at least one corrosion control component (BK), and
volatile constituents (BL), wherein the aqueous primer coating composition (B) comprises an organic solvent content of not more than 15% by weight, based on the volatile constituents (BL) of the coating composition (B),
(2) drying the integrated pretreatment film formed from the primer coating composition (B),
(3) applying a topcoat film (D) to the integrated pretreatment film dried as per step (2), and
(4) jointly curing the films of coating composition (B) and topcoat (D).

2. The method of claim 1, wherein the drying of step (2) of the method is carried out at a peak metal temperature (PMT) below a DMA onset temperature for reaction of the crosslinkable constituents of the binder system (BM).

3. The method of claim 2, wherein the drying as per step (2) of the method is carried out at a peak metal temperatures (PMT) between 40 and 120° C.

4. The method of claim 1, wherein the integrated pretreatment film contains, after drying, a residual volatile constituent (BL) content of not more than 10% by weight, based on the coating composition (B).

5. The method of claim 1, wherein the binder system (BM) comprises thermally crosslinkable constituents.

6. The method of claim 1, wherein the binder system (BM) comprises at least one water-soluble or water-dispersible binder based on polyesters and/or polyurethanes.

7. The method of claim 1, wherein at least one of the binder components of the binder system (BM) used is an aqueous dispersion of a water-soluble or water-dispersible binder, in which the dispersion has a residual solvent content of not more than 1.5% by weight, based on the volatile constituents of the dispersion.

8. The method of claim 1, wherein the aqueous primer coating composition further comprises at least one crosslinker (V) having a residual solvent content of less than 1.0% by weight, based on the volatile constituents of the crosslinker (V).

9. The method of claim 1, wherein the corrosion control component (BK) comprises at least one combination of organic and inorganic corrosion inhibitors, the corrosion control components (BK) having residual solvent contents of less than 1% by weight, based on the volatile constituents of the corrosion control components (BK).

10. The method of claim 1, wherein the curing as per step (4) of the method is carried out at a peak metal temperatures (PMT) between 150 and 260° C.

11. The method of claim 1, wherein the aqueous primer coating composition (B) is applied in step (1) by a forward roller coating process (co-directional transfer) or by a reverse roller coating process (counter-directional transfer).

12. The method of claim 11, comprising employing a coil speed of between 80 and 150 m/min, an application roll having a peripheral speed which is 110% to 125% of the coil speed, and a pick-up roll having a rotational speed which is 15% to 40% of the coil speed.

13. The method of claim 1, wherein the metal coil for coating comprises a material selected from the group consisting of iron, steel, zinc or zinc alloys, magnesium or magnesium alloys, and aluminum or aluminum alloys.
